(19) United States
(12) Patent Application Publication
(10) Pub. No.: US 2008/0207472 A1
(43) Pub. Date: Aug. 28, 2008

(54) Drilling mug lubricant and shale stabilizer

(76) Inventor: Michael Valls, New Iberia, LA (US)

Correspondence Address: KEATY PROFESSIONAL LAW CORPORATION;THOMAS S. KEATY, 2 CANAL STREET, 2140 WORLD TRADE CENTER, NEW ORLEANS, LA, 70130, US

(21) Appl. No.: 12/072,305

(22) Filed: Feb. 26, 2008

Related U.S. Application Data
(60) Provisional application No. 60/903,654, filed on Feb. 27, 2007.

(51) Int. Cl. C10M 103/02; C09K 8/68

(52) U.S. Cl. 508/115; 508/113; 507/213

(57) ABSTRACT

A well drill lubricant and shale stabilizer employs a sugar alcohol, such as glycerin or crude glycerol and graphite beads suspended in the liquid alcohol. A viscosity agent, such as a gum, is added to improve viscosity along with water. Some impurities present in crude glycerol, such as ash, methanol and MONG are present in small amounts. The composition is non-toxic, fully biodegradable, while possessing high coefficient of lubricity.

### CROSS-REFERENCE TO RELATED APPLICATIONS

This application is a non-provisional application based on my provisional application Ser. No. 60/903,654 filed on Feb. 27, 2007 entitled “Drilling Mud Lubricant,” the priority of which is hereby claimed and the full disclosure of which is incorporated by reference herein.

### BACKGROUND OF THE INVENTION

This invention relates to lubricants and more particularly to a lubricant for use in a drilling mud or other drill fluid.

Extended depth rotary drilling has presented many problems to the operator that can be companies that design the well bore based on surface to target location, such as oil companies geologists and engineers. Over the years, rotary drilling failures have been addressed and improved upon in many ways. The present invention may its particular useful application in the drilling fluid additives specifically designed to reduce “torque and drag.”

Bore holes (wells) that are drilled in the soil are not true vertical wells. Depending on the conditions of the soil and the location of the mineral deposits, the wells can deviate widely from a strictly vertical orientation. Bore holes are constantly fighting torque, dull or improper bits, formation dips, unconsolidated sands and shale and many other factors which send the hole in various directions and angles, not pre-designed for the particular project at hand. Many “vertical” wells have built high degrees of angle over short intervals and in many cases, walked away from the proposed target.

With the advent of early directional drilling, techniques were developed to “correct” the path of the well axis deviation so as to gain a closer proximity to the proposed target. In these “vertical” holes, the angles and turns created by these deviations combined with swelling or depleted formations contributed to greater torque and drag on the drill string. Drill string “stabilizers” helped maintain an orientation of the bore hole, but additionally increased the torque and drag associated with rotary drilling.

Many products have been introduced into the drilling market to address these factors and have greatly improved the performance of the procedures, many still be in use today. With the advances in the directional drilling industry, the operators are now in a position to form the wells with more precision. With this ability to “twist and turn” the well bore, greater strains have been placed on the drill string than ever before.

Drilling fluid companies are constantly developing new products (lubricants) that will ease this strain. Drill string manufactures are designing components that can withstand greater tensile and torsional parameters created by the deviated well bores. Directional drilling is “governed” by the ability to “slide” the drill string down hole instead of rotating the entire string, as is customary with conventional vertical drilling. When the pipe is rotated, torque is increased on the drill string but drag is decreased allowing weight to assist the drill bit in cutting the formation. When directional drilling procedures are necessary for steering purposes, the drill string is now in a “non-rotating” mode. The torque is decreased; however the drag is increased and is multiplied exponentially with every increase in angle, turn and depth, not to mention ledges and swollen formations.

With the greater use of directional drilling in the oil & gas, geothermal, utility and governmental venues, well designs have reached out under cities and lakes, rivers and mountains and have greatly improved the utilization of offshore platforms as multi-well structures. To satisfy the needs of directional drilling, many companies introduced different lubricants in an effort to increase lubricity. Various products have been “tested,” some with success and others catastrophic failures. The products developed for the purpose of lubrication must first and foremost, be responsive to the well bore formations. Care must be taken in the development of a new product so that it does not inhibit the wells production or cause “swelling” of formations.

Many fluids and additives used today are not environmentally friendly. Special precautions must be taken, at great expense, to assure that these products do not make contact with the ocean waters. The present invention contemplates elimination of drawbacks associated with conventional drilling mud lubricants and provision of a biodegradable additive that has high lubricity and is safe enough to be introduced into the surrounding environment.

### SUMMARY OF THE INVENTION

It is, therefore, an object of the present invention, to provide a drilling fluid lubricant that has high lubricity suitable for use in directional drilling.

It is another object of the present invention to provide a drill mud lubricant that is biodegradable.

It is a further object of the present invention to provide a shale stabilizer having low toxicity.

These and other objects of the invention are achieved through a provision of a composition that can be used in water base drill mud as a lubricant and/or shale stabilizer. The lubricant/shale stabilizer composition contains a sugar alcohol, such as glycerol or glycerin, which can be derived from the process known as transesterification, whereby the glycerin is separated from the fat or vegetable oil. The process leaves behind two products—methyl esters (the chemical name for biodiesel) and glycerin (a byproduct usually used in soaps and other products). The secondary component of the lubricant comprises graphite “beads.” It is envisioned that in one of the embodiments, the composition will contain at least 50% glycerin/glycerol, by weight. In a more preferred embodiment, the composition contains, by weight, between about 85 and 90 percent of sugar-alcohol-containing substance, such as glycerol, between 5 and 10 percent of graphite beads or powder, about 1 percent of water and equal amount of a viscosity-modifying agent, such as gum, as well as some substances present in crude glycerol, such as methanol, ash and matter of organic non-glycerol (MONG).

Glycerin is known for its lubricity and ability to “attach” itself to surfaces. The second is as important as the first so the product does not get washed away, out of the well bore. Graphite, in itself, is very slick and has been used as a “dry” lubricant in many environments. The “beads”, which have been on the market in many forms today (glass, polymer), act as ball bearings in the hole and allow for reduced side wall friction. The lubricity of graphite results from the sliding of the graphite particles with each other. When admixed with glycerin, a fully biodegradable product, the graphite beads remain dispersed in the drilling mud system, providing much higher lubricity as compared to the lubricity values of graphite alone or glycerin alone.

The glycerin carrier-coated graphite beads are expected to minimize fluid loss in the well by forming a filter cake on the walls of the well in a water-based mud. The hydrophilic, glycerin-coated graphite beads fill the crevices of the well bore and prevent the fluid loss into the surrounding formation.

The resultant composition has physical characteristics of an odorless oily liquid, with the graphite beads suspended therein. The mixture has a flash point is in the order of 199° C. (390° F.), pH of 1.26 @20C/4C, melting point of 18° C. (64° F.) and boiling point of 290° C. (554° F.). When released into the soil, the lubricant composition is expected to be biodegradable and will not significantly evaporate. When released into water, the lubricant composition of the instant invention is expected to be fully biodegradable and not be toxic to aquatic life.

### DETAILED DESCRIPTION OF THE PREFERRED EMBODIMENT

The present invention concerns a lubricant composition that may be used in directional drilling in place of conventional hydrocarbon-based drilling mud. The lubricant composition of the instant invention contains a sugar alcohol selected from the group comprising glycerol and glycerin, graphite beads or powder as the active ingredients. The composition also contains a small amount of viscosity agent, more particularly a gum selected from the group comprising xanthum, diutan or guar gum. Depending on the purity of starting material, crude glycerol, the glycerin-containing substance used in the composition of the instant invention may contain by total weight, between 85 and 90% glycerin-containing substance, such as glycerol and between 5 and 10% graphite beads. The composition may also contain water, gum, as well as small percent of impurities present in crude glycerol.

When crude glycerol is mixed with the graphite beads, the resultant composition has between 85 and 90 percent of glycerin, between 5 and 10 percent of graphite beads or powder, about 1 percent of water and equal amount of liquefied viscosity agent, such as gum. The composition may also contain small amount of methanol, about 1% by total weight, and substantially similar amounts of ash and matter of organic non-glycerol (MONG), which are defined as impurities in the crude glycerol.

The impurities in the glycerol are usually the result of high pressure hydrolysis of the oils and fats into glycerol and fatty acids, whereby a mixture of two phases is obtained, namely a heavy glycerol/water phase and a light fatty acid phase which is removed from the mixture by gravity separation. However, small quantities of fatty acids and other fats cannot be prevented from being removed with the glycerol/water phase. The small quantities of secondary products which are formed during the hydrolysis, for example diglycerides and monoglycerides, and triglycerides are also present in the sweet water. Glycerol, a sugar alcohol with the formula HOCH₂CH(OH)CH₂OH. It is a colorless, odorless, viscous liquid with sweet taste and low toxicity. Glycerol has three hydrophilic alcoholic hydroxyl groups that are responsible for its solubility in water and its hydroscopic nature. Its surface tension is 64.00 mN/m at 20° C., and it has a temperature coefficient of −0.0598 mN/(m K).

Glycerol, the main component of glycerin, has the chemical formula C3H5(OH)3. In the lubricant composition of the instant invention, the virtual non-toxicity and overall safety of glycerin affords a significant benefit of safety and biodegradability of the lubricant.

The gum is used to facilitate graphite bead suspension in glycerin and improve viscosity of the lubricant composition. Combined with the main ingredients the gum produces shale stabilizing effect, which is a must for drilling fluids in the Gulf Coast. The shale stabilizing effect is based on the known hydrophilic properties of glycerin tending to absorb large amount of moisture and water.

Diutan gum belongs to a class of rheology modifying agents possessing pseudoplastic behavior. Pseudoplastic materials are characterized by viscosity which increases and decreases virtually instantaneously in response to the removal and application of shear. This property results in fluids which readily flow but are capable of suspending or stabilizing components.

Xanthum or Xanthan gum that can be used alternatively with the diutam gum, is capable of producing a large increase in the viscosity of a liquid by adding a very small quantity of gum, on the order of one percent. Xanthan gum is an anionic polyelectrolyte with a β-(1→4)-D-glucopyranose glucan (as cellulose) backbone with side chains of -(3→1)-α-linked D-mannopyranose-(2→1)-β-D-glucuronic acid-(4→1)-β-D-mannopyranose on alternating residues. Slightly less than half (˜40%) of the terminal mannose residues are 4,6-pyruvated and the inner mannose is mostly 6-acetylated (that is, the side chains are mainly β-D-mannopyranosyl-(1→4)-(α-D-glucuronopyranosyl)-(1→2)-β-D-mannopyranoside-6-acetate-(1→3)-. Some side chains may be missing.

Xanthan gum is mainly considered to be non-gelling and used for the control of viscosity. It hydrates rapidly in cold water without lumping to give a reliable viscosity in the lubricant composition of the instant invention with beads' suspension in glycerin. Xanthan gum's most important property being its very high low-shear viscosity coupled with its strongly shear-thinning character facilitates formation of a lubricant composition with the viscosity factor suitable for use in well-drilling operations.

Alternatively, guar gum may be used as a viscosity agent in the lubricant composition. Guar gum is derived from a plant material; it is primarily the ground endosperm of guar beans and is typically produced as a free flowing, pale, off-white colored, coarse to fine ground powder. Guar gum is nonionic and hydrocolloidal in water. It is insoluble in most hydrocarbon solvents. Guar gum shows high low-shear viscosity but is strongly shear-thinning. It has much greater low-shear viscosity than that of locust bean gum, and also generally greater than that of other hydrocolloids. Guar gum has water-thickening potency producing sufficient viscosity even in small amounts. It also acts as a stabilizer, preventing the graphite beads from settling.

In preparing the test composition of the instant invention, about 0.5 lbs of gum were mixed with 11 gallons of water. About 1.25 gallons of the mixture of water and gum were added to 55-gallons drum containing about 35 gallons of crude glycerol and 135 lbs of graphite beads. The resultant mixture was mixed to allow the graphite beads to become suspended in the liquid glycerol. The amount of the viscosity agent will largely depend on the well bore stability and lubrication needs.

The lubricant composition of this invention has a number of advantages in comparison to the hydrocarbon-based lubricants. It is twelve times more lubricating than petro diesel; it is hydrophilic, which is an important property in water sensitive shale that exhibits differential sticking. The lubricant presents an excellent shale stabilizer and does not require as much volume as mineral oil as well as being less expensive. Since it has more lubricating capabilities, the composition will minimize the operational time of well drilling.

In conventional directional wells, when the angle and turn or build and drop of the well bore increases, the pipe begins to drag and torque increases. The use of the lubricant according to the present invention is expected to substantially reduce torque and drag, due to the lubricity coefficient characteristics of the composition. Current state of the art is the use of mineral oil and synthetic products. The instant composition demonstrated in tests several times greater lubricity coefficient than the current state of the art hydrocarbon-based lubricant.

The lubricant also acts as a shale stabilizer due to its hydrophilic properties. This is thermodynamically favorable, and makes these molecules soluble not only in water, but also in other polar solvents. There are hydrophilic and hydrophobic parts of the cell membrane. A hydrophilic molecule or portion of a molecule is one that is typically charge-polarized and capable of hydrogen bonding, enabling it to dissolve more readily in water than in oil or other hydrophobic solvents. Hydrophilic and hydrophobic molecules are also known as polar molecules and nonpolar molecules, respectively. When drilling a well it is critical that when the drilling through shale that a barrier is created to prevent dissolution of the shale wall that is created. Pressure from the shale to the drill bore must be equalized or overburdened. When using a water-based drilling mud, the water may tend to dissolve the shale wall creating a condition called sloughing of the shale. This will cause the drill pipe to stick. An overburdened hydrostatic mud column creates an inverse to the above, whereby water is lost into the formation at times so great that it creates what is caused differential sticking.

The lubricant composition of this invention, due to its hydrophilic properties, prevents sloughing shale and differential sticking, while allowing the drill pipe to freely move up or down.

Another benefit of this invention is that it does not require as much volume as a conventional mineral oil because the lubricity coefficient of the main carrying agent, glycerin, is far greater than that of mineral oil, thus less is needed for better results.

Still another advantage of the instant invention is that it allows reducing time in directional drilling. Current state of the art requires the directional drilling contractor to spend hours of deliberate pipe orientation in an attempt to slide and control inclination and azimuth in a procedure called sliding. The use of the instant lubricant, due to its increased lubricity coefficient, will enable the directional drilling operator to accomplish the sliding technique with less effort and therefore a shorter period of time. About twenty five percent of the cost of drilling a directional well is due to the time spent attempting to slide the pipe. By reducing the time needed to accomplish the sliding technique, the cost of drilling the well may be reduced by about fifteen percent, a significant time savings.

I claim:

1. A lubricant composition, comprising: one or more member selected from the group consisting of liquefied sugar alcohol, a viscosity agent and mixtures thereof, and graphite beads suspended in liquefied alcohol, and wherein the composition comprises at least glycerol and a gum.

2. The lubricant composition of claim 1, wherein said sugar alcohol comprises crude glycerol.

3. The lubricant composition of claim 1, wherein the viscosity agent is selected from the group consisting of xanthan gum, diutan gum and guar gum.

4. The lubricant composition of claim 1, wherein the gum serves as a shale stabilizer.

5. The lubricant composition of claim 1, further comprising water.

6. The lubricant composition of claim 2, further comprising methanol, ash and matter of organic non-glycerol.

7. A lubricant composition for well drilling, comprising: one or more member selected from the group consisting of liquid glycerol, a gum, and graphite beads suspended in liquid glycerol, and wherein the lubricant composition comprises between about 85 and 90% by weight glycerol, between 5 and 10% by weight graphite beads, and about 1.00% by weight of gum.

8. The lubricant composition of claim 7, further comprising about 1.00% by weight water, about 1.00% by weight methanol, about 1% by weight ash and about 1.00% by weight matter of organic non-glycerol.

9. A shale stabilizer composition for well drilling operations, comprising: effective amounts of one or more members selected from the group consisting of one or more member selected from the group consisting of liquid glycerol, a viscosity agent, and graphite beads suspended in liquid glycerol, and wherein the shale stabilizer composition comprises between about 85 and 90% by weight glycerol, between 5 and 10% by weight graphite beads, and about 1.00% by weight of viscosity agent.

10. The shale stabilizer composition of claim 9, further comprising equal amounts of water, methanol, ash and matter of organic non-glycerol, of about 1.00% by weight each.

11. The shale stabilizer composition of claim 10, wherein the viscosity agent is a gum selected from the group consisting of xanthan gum, guar gum and diutan gum.
